(19) United States
(12) Patent Application Publication
(10) Pub. No.: US 2003/0034235 A1
(43) Pub. Date: Feb. 20, 2003

(54) Media conveyor belt

(75) Inventor: Vicente Claudio Amato, Sao Paulo (BR)

Correspondence Address: Brinks Hofer Gilson & Lione, P.O. Box 10395, Chicago, IL, 60610, US

(73) Assignee: Quattro Promocoes, Comercio E Representacoes LTDA.

(21) Appl. No.: 10/189,991

(22) Filed: Jul. 5, 2002

(30) Foreign Application Priority Data
Jul. 6, 2001 (BR) MU8101688-3

(51) Int. Cl. B65G 43/00; G09F 11/12

(52) U.S. Cl. 198/846; 198/502.1; 40/524; 186/68

(57) ABSTRACT

In the present invention, a media conveyor belt (1) presents an arrangement that will allow the publishing of all kinds of messages, thus maximizing its utilization. This media conveyor belt has a purpose to allow the display of every kind of message and information on its external surface, innovating not only its arrangement but also in its utilization. The media conveyor belt (1) is characterized by presenting, in its upper surface (2), the application of messages (3).

### BACKGROUND OF THE INVENTION

This utility model patent application is related to a new media conveyor belt, which shall apply to the conveyer belts widely used in all kinds of logistic planning, being distinguished for a presentation unknown to this time.

The conveyor belts have a wide scope of utilization, going from the movement of heavy vehicles by steep lands, movement and transport of cargo and material in ports and plants of every nature, to the movement of minor scale, such as we may usually see in airports and supermarket cashiers.

It is clear that millions of people throughout the world watch the latter, used for movement of luggage and goods, and always see a flat surface, normally dark, which does not transmit or adds any kind of message.

Taking into consideration the evolution of such materials movement medium, we may check that it has been subject to changes and technical progress only in their propelling, driving and support mechanisms, however the belt has been presenting as progress only small changes of material in its construction.

The belt evolution, therefore, was limited to its internal portion. The external portion was left forgotten and continues untouched by the technique, which has not been showing concern to it.

It is certain that, taking into consideration the huge utilization of the conveyor belts in the quotidian life of millions of people, it is required the presentation of a new external arrangement, so as that such product may increase its functionality, adding a new utilization, concurrently with the current one.

In order to face such issue, the inventor herein made the strongest efforts in order to solve them, which actually happened with the invention described below.

### BRIEF SUMMARY OF THE INVENTION

In the present invention, a media conveyor belt (1) presents an arrangement that will allow the publishing of all kinds of messages, thus maximizing its utilization. The media conveyor belt (1) is characterized by presenting, in its upper surface (2), the application of messages (3).

### BRIEF DESCRIPTION OF SEVERAL VIEWS OF THE DRAWINGS

FIG. 1 is an advertising space on a media conveyor belt.

### DETAILED DESCRIPTION OF THE INVENTION

The present preferred embodiment of the invention is described herein with reference to the drawing, where like components are identified with the same reference numerals. These descriptions are intended to be exemplary, in nature are not intended to limit the scope of the invention.

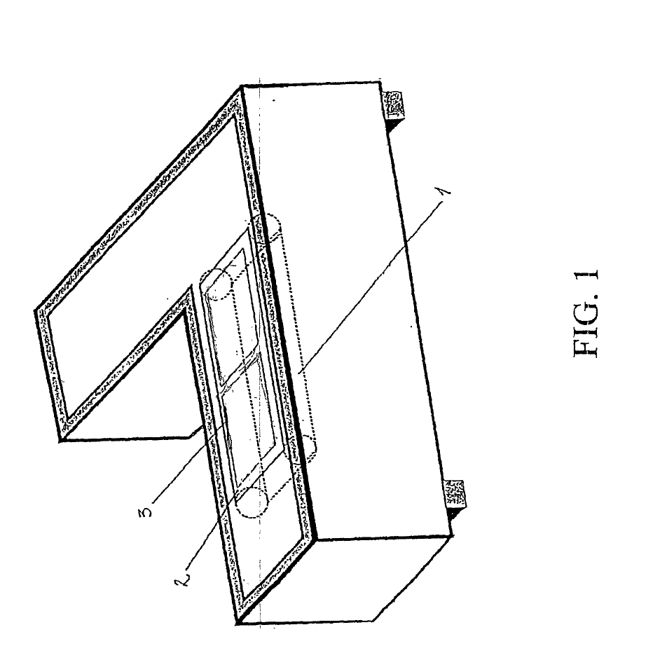

For the perfect visualization of the invention, the drawing below is presented where it can be seen. FIG. 1 is an advertising space on a media conveyor belt. In an example, the media conveyor belt can be a supermarket conveyor belt used by a cashier. The media conveyor belt illustrated herein (1) presents in its external surface (2) the insert of messages (3), which shall be applied to support the friction with all material conveyed by the belt without any kind of damage to the information comprised therein.

As the belt is doing its movement work, several messages will displayed to its user, allowing him/her to receive the information while expecting, supervising or taking the product conveyed by media conveyor belt.

The new arrangement will allow a fully ignored space of conveyor belts, be them in airports, bus stations, supermarkets, etc., to have a new function, significantly maximizing their utilization.

2. A belt conveyor system, the system comprising:
an endless conveyor belt;
first and second rollers;
the endless conveyor belt following a conveyance path from the first roller to the second roller and a return path from the second roller to the first roller; and
wherein the endless conveyor belt is configured to display messages.

3. The system of claim 2 wherein the messages are text messages.

4. The system of claim 2 wherein the messages further comprises images.

5. The system of claim 2 wherein the messages further comprises images and text.

6. The system of claim 2 wherein the conveyor belt further comprises at least two sections.

7. The system of claim 6 wherein the messages are displayed on the at least two sections.

8. The system of claim 2 wherein the conveyor belt further comprises an internal surface and an external surface.

9. The system of claim 8 wherein the messages are displayed on the external surface of the conveyor belt.

10. A belt conveyor apparatus, the apparatus comprising:
a conveyor belt configured to display text messages, wherein the conveyor belt is configured to follow a conveyance path from the first roller to the second roller and a return path from the second roller to the first roller; and
wherein the text messages are conveyed on the conveyor belt.

11. A belt conveyor apparatus, the apparatus comprising:
a conveyor belt configured to display messages, wherein the messages include images, wherein the conveyor belt is configured to follow a conveyance path from the first roller to the second roller and a return path from the second roller to the first roller; and
wherein the messages are conveyed on the conveyor belt.

12. A belt conveyor apparatus, the apparatus comprising:
a conveyor belt configured to display messages, wherein the messages include images and text, wherein the conveyor belt is configured to follow a conveyance path from the first roller to the second roller and a return path from the second roller to the first roller; and
wherein the messages are conveyed on the conveyor belt.
